(19) United States
(12) Patent Application Publication
(10) Pub. No.: US 2017/0232781 A1
(43) Pub. Date: Aug. 17, 2017

(54) DEVICE FOR JOINING TWO WRITING INSTRUMENTS

(71) Applicant: Andrew Nguyen, Huntington Beach, CA (US)

(72) Inventor: Andrew Nguyen, Huntington Beach, CA (US)

(21) Appl. No.: 15/041,680

(22) Filed: Feb. 11, 2016

(51) Int. Cl. B43K 23/06; F16B 2/22

(52) U.S. Cl. CPC B43K 23/06; F16B 2/22

(57) ABSTRACT

This invention provides a device for removably connecting two different styles of writing instruments, such as pens with different colored inks or different size nibs, pencils, markers, or crayons.

### CROSS-REFERENCES

None.

### STATEMENT REGARDING FEDERALLY-SPONSORED RESEARCH OR DEVELOPMENT

None.

### NAMES OF PARTIES TO JOINT RESEARCH AGREEMENT

None.

### REFERENCE TO “SEQUENCE LISTING”

None.

### SUMMARY OF INVENTION

The nature of the problem addressed here is how to simplify access to multiple writing implements for use at one time. It is typical in schools, universities, industry and professional practices for an individual to rely on several different types of writing instruments for making notes and then for emphasis such as underscoring or highlighting, or to sort information or data by priority. For instance, a person may wish to use black pencil or blue ink for note taking, but insert red ink or yellow marker to identify key points.

Currently, some students and practitioners rely on a single pen with multiple ink cartridges or a pen with two business ends. This gives the convenience of reasonably uninterrupted writing. However, the problem created is that one ink cartridge is usually depleted or one color of pencil graphite is consumed before the others which defeats the purpose of a single pen or pencil. Other writers cobble different instruments together with a rubber band or tape. The purpose of combining the instruments is convenience, to avoid hunting for another writing instrument when needed. The problem created is rubber bands or tape have relatively low breaking points. Clips have routinely been attached to pens or pencils to provide the convenience of allowing the pen or pencil to be removably affixed to a person's pocket or other carrying device. Clips have not previously been used to removably join pens or pencils for writing.

My invention promotes convenience by providing a flexible housing to hold each instrument, while providing longer life span for a coupling of the different instruments. The invention is comprised of one piece or two piece semi-cylindrical housings into which assorted types of writing instruments, such as pens with different colored inks or with different nib sizes, wooden pencils, mechanical pencils, drafting pencils, markers, and crayons for that matter, can be inserted. In an embodiment, the flexible housing can be made of soft plastic, rubber, or metal.

The housing can have varying diameters to allow for insertion of thin, mid-size and thick pens, pencils or other writing instruments. In an embodiment, an inner standard diameter for at least one side of the housing would accommodate a No. 2 pencil or a BIC™ pen. The other side of the housing could have the same size inner diameter, or a larger or smaller diameter, depending on intended uses of an author or writer.

### DRAWINGS

4, described as follows:

FIG. 1 contains a perspective view of a mechanical pencil coupled to a standard graphite pencil.

FIG. 2 contains a disassembled view showing a one-piece coupler.

FIG. 3 contains a perspective view of another embodiment showing a two-piece coupler.

FIG. 4 contains a perspective view showing another embodiment of the coupler.

### DETAILED DESCRIPTION OF DRAWINGS

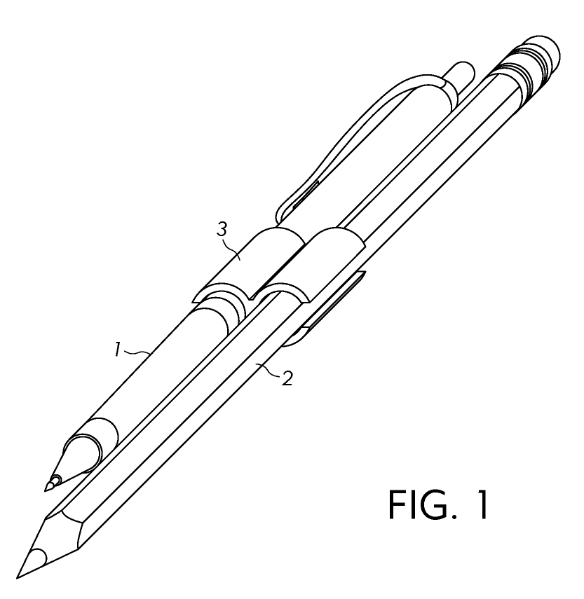

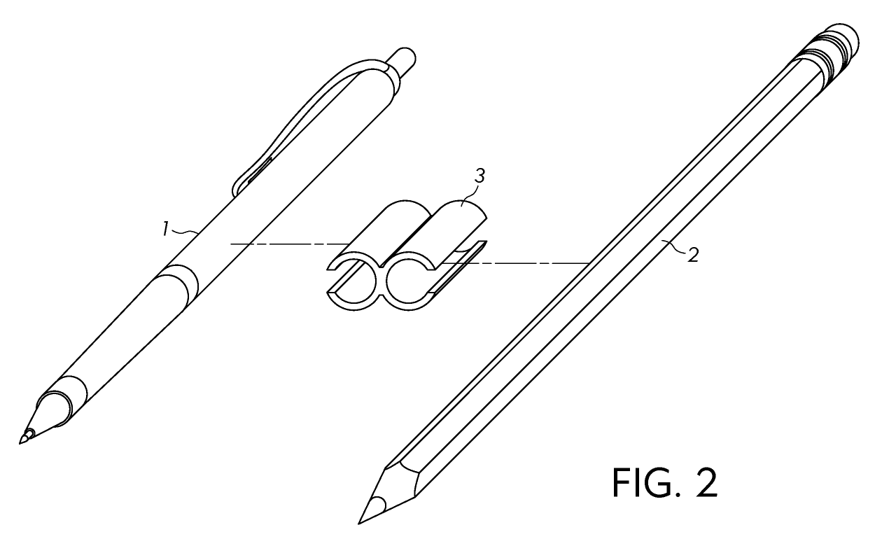

In single piece construction, two approximately, semi-cylindrical housings are permanently joined to form the coupling device 3, as shown in FIG. 1. In an embodiment, a mechanical pencil 1 is removably coupled to a standard pencil 2. When the lead/graphite (for convenience, graphite) is depleted, then in the mechanical pencil, a new column of graphite can be inserted. When the graphite in the standard pencil is depleted, the pencil can be sharpened. There are a multitude of combinations where a pen, marker or crayon, for instance, can be substituted for either of the portrayed writing instruments. An exploded view reveals how either writing instrument can be detached from the coupling device 3, in FIG. 2.

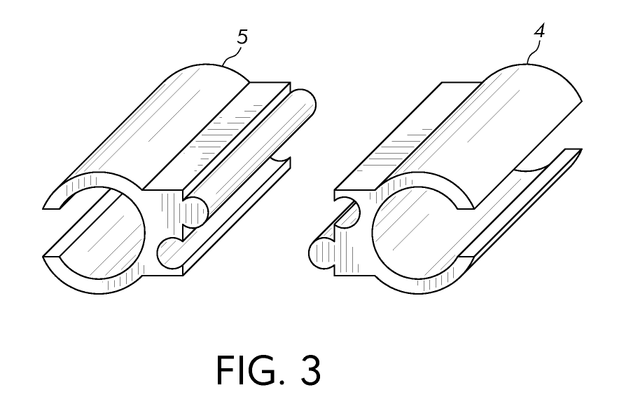

In two piece construction, two approximately, semi-cylindrical housings are removably joined by tongue and groove, as in FIG. 3. A first housing 4 has a protruding tongue and recessed groove designed to allow it to mate by sliding into the tongue and groove of a second housing 5.

The purpose for having one piece or two piece construction is that the housings can be attached to several different writing instruments. Instead of replacing the writing instrument, the housings can be slid together to allow for continuance writing.

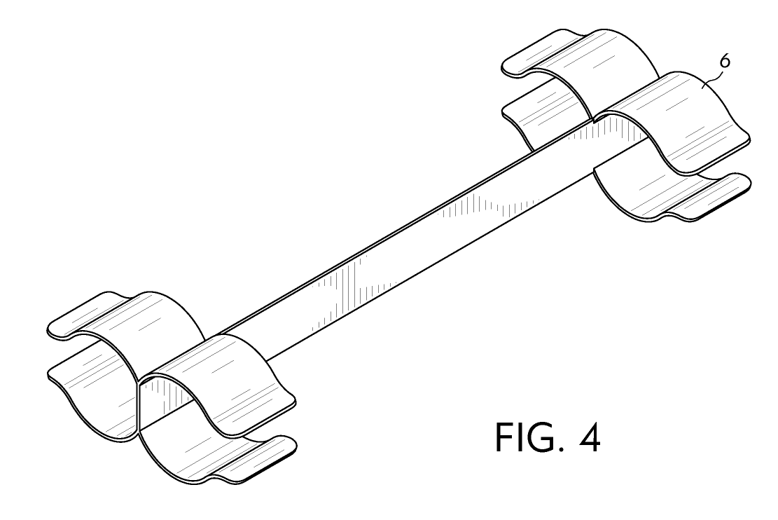

In FIG. 4 another version of the coupling device 6 is shown. In this embodiment, which comprises two joined semi-cylindrical housings connected by a spinal column, a writing instrument is inserted into both openings of the housings. The advantage of multiple housings is simply better control over the writing instrument. After the writing instruments are inserted, the individual can use one or the other instrument by merely tilting his or her hand. This embodiment may be useful where prolonged writing at a single time with different diameter instruments is anticipated. The stabilizing device is designed to prevent slippage of the instrument that is not in current use.

The above description of the preferred embodiment of the present invention has been presented for the purposes of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims.

I claim:

1. A device for joining two writing instruments, comprising:
a coupler which contains two semi-cylinders each having an opening, that are joined to form one housing;
where the coupler is made of flexible material; and,
where a writing instrument can be removably inserted into each opening of the housing and snapped into a fixed position.

2. The device of claim one, where the diameter of one opening of the housing is at least twice as large as the diameter of the other opening of the housing.

3. A device for joining two writing instruments, comprising:
a first housing which is an approximately semi-cylindrical structure, that is made of flexible material;
where the first housing has a centrally located and protruding tongue with recessed groove;
a second housing which is an approximately semi-cylindrical structure, that is made of flexible material;
where the second housing has a centrally located and protruding tongue with recessed groove;
where the first housing and second housing can be joined by sliding; and,
where a writing instrument can be removably inserted into each side of the housings and snapped into a fixed position.
